(19) United States
(12) Patent Application Publication
(10) Pub. No.: US 2004/0122566 A1
(43) Pub. Date: Jun. 24, 2004

(54) Apparatus and method for providing automated brake pipe testing

(75) Inventors: Folkert Horst, Pierrefonds (CA); Oleh Szklar, St-Hubert (CA)

Correspondence Address: DARBY & DARBY P.C., P. O. BOX 5257, NEW YORK, NY, 10150-5257, US

(73) Assignee: CANAC INC., St-Laurent (CA)

(21) Appl. No.: 10/728,317

(22) Filed: Dec. 2, 2003

Related U.S. Application Data
(60) Provisional application No. 60/434,647, filed on Dec. 20, 2002.

(51) Int. Cl. G06F 7/00

(52) U.S. Cl. 701/2; 701/19

(57) ABSTRACT

The present invention relates to a transmitter for remotely controlling and testing a train. The train has a slave controller mounted in the locomotive that is in communication with the transmitter. The transmitter comprises a control entity for issuing a plurality of commands to the slave controller and for causing corresponding actions to be performed at the train. The plurality of commands includes a brake testing command for causing a brake pipe test to be initiated at the train. In addition, the transmitter includes a communication entity that is in communication with the control entity for receiving commands issued by the control entity and for transmitting a signal over a communication link to the slave controller for conveying the commands issued by the control entity.

### CROSS-REFERENCE TO RELATED APPLICATIONS

This application claims the benefit of U.S. provisional application serial No. 60/434,647 filed Dec. 20, 2002. The contents of the above document are incorporated herein by reference.

### FIELD OF THE INVENTION

The present invention relates generally to the field of train control systems, and, more specifically, to an apparatus and a method for performing brake pipe testing.

### BACKGROUND OF THE INVENTION

In order to meet with safety regulations, the braking system of a train must be tested on a regular basis, such as before every new journey. This is to ensure that the brakes of the train are functioning properly before the train is put into use. For example, in the U.S., 49CFR Chapter II §232 describes brake safety standards for freight and other non-passenger trains and equipment as well as end-of-train devices. The contents of this document are hereby incorporated by reference.

There are two types of brake pipe tests that are commonly used for testing the braking system of a train. The first type of test is typically referred to as a “brake pipe leakage test”, and the second type of test is typically referred to as an “air flow test”.

A brake pipe leakage test is typically conducted by charging the air brake system with a pressure regulator to the pressure at which the train will be operated. The brake pipe is considered to be charged when the pressure at the end of the train is within 15 psi of the pressure at which the train will be operated, but not less than 75 psi. A pressure gauge or end of train unit is used to measure the pressure at the rear of the train. In order to apply the brakes, a 20 psi brake pipe service reduction is caused. With the brake valve lapped and any pressure maintaining functionality for the brake pipe disabled, after a delay period typically in the range of 45-60 second, the brake pipe leakage is noted by a brake pipe gauge. If the brake pipe leakage is less than 5 psi per minute, the brake pipe leakage test is considered to have been passed. Generally, in order to perform the above described brake pipe leakage test, two operators are required. A first operator is required at a first end of the brake pipe in order to operate the pressure regulator that adjusts the pressure within the chamber to the pressure at which the train will be operated. A second operator is required at a second end of the brake pipe in order to take a pressure reading using a pressure gauge at the end of the brake pipe opposite from the pressure regulator. The operator at the end of the brake pipe takes a measurement of the pressure at the end of the brake pipe in order to ensure that it is within 15 psi of the predetermined level and not less than 75 psi. Once the pressure at the end of the brake pipe is satisfactory, the second operator communicates with the first operator so that the first operator can cause a brake pipe service reduction of 20 psi.. Following this, the second operator waits a predetermined amount of time, and then takes a measurement using the pressure gauge. The rate of leakage can be determined based on the initial pressure reading and the reading taken after a predetermined amount of time. In general, in order to pass the test, the leakage cannot exceed 5 psi/min.

An airflow test is typically conducted by charging the air brake system with a pressure regulator to the pressure at which the train will be operated. The brake pipe is considered to be charged when the pressure at the end of the train is within 15 psi of the pressure at which the train will be operated, but not less than 75 psi. A pressure gauge or end of train unit is used to measure the pressure at the rear of the train. Once the brake pipe is charged, the airflow from the pressure regulator is measured to determine the air flow required to maintain the desired pressure. Typically, the airflow test is considered to be passed if the airflow not exceed 60 cubic feet per minute. Generally, two operators are also required in order to perform the airflow test. A first operator is required at a first end of the brake pipe in order to operate the pressure regulator that adjusts the pressure within the chamber to the pressure at which the train will be operated. A second operator is required at a second end of the brake pipe in order to take a pressure reading using a pressure gauge at the end of the brake pipe opposite from the pressure regulator. The operator at the end of the brake pipe takes a measurement of the pressure at the end of the brake pipe in order to ensure that it is within 15 psi of the predetermined level and not less than 75 psi. Once the pressure at the end of the brake pipe is satisfactory, the second operator communicates with the first operator so that the first operator can measure the air flow supplied to the brake pipe in order to maintain the pressure within the brake pipe at the predetermined level. If the pressure within the brake pipe is maintained at the predetermined level, then the rate of airflow entering the brake pipe is directly related to the rate of leakage of air from the brake pipe. In general, in order to pass the test, the rate of airflow must not exceed 60 cubic feet per minute.

Therefore, both the brake pipe leakage test, and the air flow test require a duplication of the amount of personnel that is required to operate a train, thereby incurring additional costs in the form of an extra operator. Furthermore, the mobility of the personnel is limited since one operator must physically measure the brake pipe pressure at one end of the brake pipe and the other must control the pressure regulator at the other end of the brake pipe. This can be costly for the railway companies.

Alternatively, the train may include an end of train unit. The end of train unit is positioned at the end of the train opposite the location of the pressure regulator is adapted for obtaining a pressure measurement from the end of the brake pipe. The end of train unit is also enabled to communicate this measurement to an operator controlling the pressure regulator such as to allow the latter to monitor the brake pipe pressure at the end of the train. In such a configuration, a single operator is required at the pressure regulator. However, the mobility of the personnel is still limited since the operator must control the pressure regulator at the other end of the brake pipe and monitor the incoming pressure measurements from the end of train unit.

Against this backdrop, it is apparent that there exists a need in the industry for an apparatus and method for performing brake pipe testing that alleviates at least in part some of the problems associated with the prior art methods of performing brake pipe testing.

### SUMMARY OF THE INVENTION

In accordance with a first broad aspect, the present invention provides a transmitter for remotely controlling and testing a train having a locomotive in which is mounted a slave controller. The transmitter comprises a control entity for issuing a plurality of commands to the slave controller and for causing corresponding actions to be performed at the train. The plurality of commands includes a brake testing command for causing a brake pipe test to be initiated at the train. In addition, the transmitter includes a communication entity that is in communication with the control entity for receiving commands issued by the control entity, and for transmitting a signal over a communication link to the slave controller conveying the commands issued by the control entity.

In accordance with a second broad aspect, the present invention provides a slave controller for use in a locomotive having a control interface. The slave controller includes a control entity and a communication entity that is in communication with the control entity. The communication entity receives signals from a remote transmitter over a communication link to convey commands to the slave controller for causing corresponding actions to be performed at the locomotive. The control entity is responsive to a brake testing command for issuing local control signals to the control interface for causing a brake pipe test to be initiated.

In accordance with a final broad aspect, the present invention provides a method for remotely controlling and testing a train having a locomotive in which is mounted a slave controller. The method comprises providing a transmitter having a user interface for receiving a plurality of commands from the user. The plurality of commands includes a brake testing command for causing a brake pipe test to be initiated at the train. In response to a command entered at the user interface by the user, the method involves generating internal signals representing the command entered at the user interface, and using the internal signals to generate a communication with the slave controller for conveying the command entered at the user interface.

### BRIEF DESCRIPTION OF THE DRAWINGS

A detailed description of examples of implementation of the present invention are provided hereinbelow with reference to the following drawings, in which:

FIG. 1 is a schematic view of a train in accordance with a specific embodiment of the present invention, having a brake pipe and a slave controller mounted in the locomotive;

FIG. 2 is a functional block diagram of a transmitter for remotely controlling and testing the brake pipe of a train in accordance with a specific embodiment of the present invention, the train having a slave controller mounted in the locomotive;

FIG. 3 is a functional block diagram of a slave controller mounted in the locomotive of a train that is in communication with a control interface of the train in accordance with a specific embodiment of the present invention;

FIG. 4 is a flow diagram of a method of performing brake pipe testing in accordance with a specific embodiment of the present invention.

In the drawings, embodiments of the invention are illustrated by way of example. It is to be expressly understood that the description and drawings are only for the purposes of illustration and as an aid to understanding, and are not intended to be a definition of the limits of the invention.

### DETAILED DESCRIPTION

The following description relates to an apparatus and method for performing brake pipe testing. More specifically, the brake pipe testing is either a brake pipe leakage test or an air flow test, either one of which can be used to determine if the amount of air leaking from a train's brake pipe is within an acceptable range.

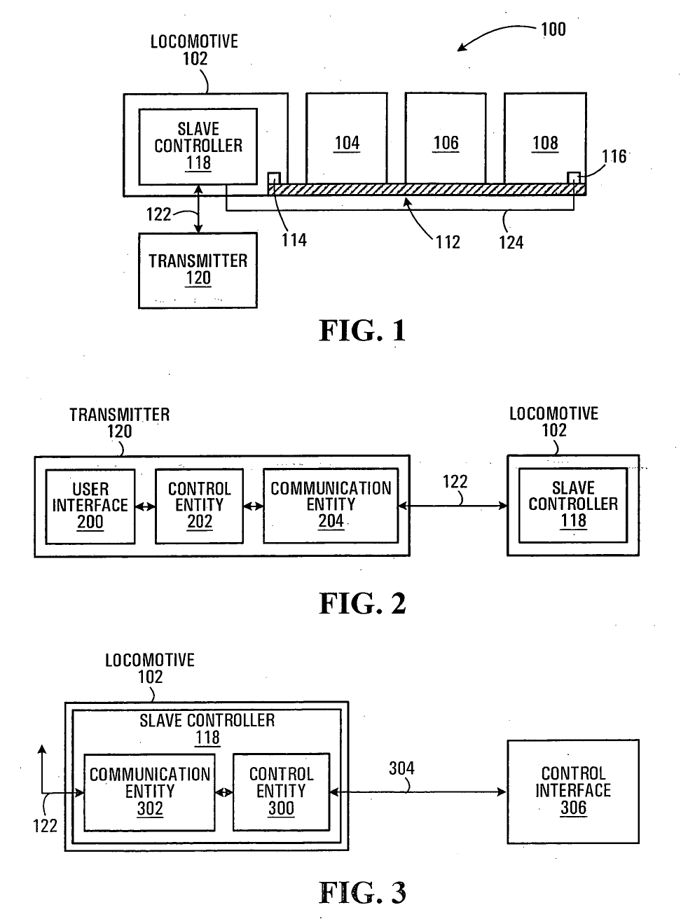

Shown in FIG. 1 is a schematic diagram of a train configuration 100 of the type that could be used advantageously in connection with an embodiment of the present invention. The train configuration 100 includes a locomotive 102, a first railway car 104, a second railway car 106, and a third railway car 108. A train having more than one locomotive 102, and more or less railway cars could also be used advantageously in connection with an embodiment of the present invention. In addition, it should be understood that it is not essential for the present invention that the locomotive 102 be placed at the head of the train.

Spanning the length of train configuration 100 is a brake pipe 112 containing pressurized gas, such as air. At a first end 114 of the brake pipe 112 is a pressure regulator (not shown) that is connected to a high-pressure air reservoir (not shown). The pressure regulator is operative to adjust the pressure within the brake pipe 112 by feeding air from the reservoir to the brake pipe 112. As such, the pressure regulator is able to set the pressure within the brake pipe to a predetermined level.

In a first example of implementation, where the brakes are tested using a brake pipe leakage test, a cut off valve (not shown) that is operative to stop the flow of air from the reservoir to the brake pipe is also included at the first end 114 of the brake pipe 112.

In a second example of implementation, where the brakes are tested using an air flow test an air flow sensor (not shown) for measuring the rate of air flow into the brake pipe 112 is also included at the first end 114 of the brake pipe 112.

In a third example of implementation, at the first end 114 of the brake pipe 112 are a cut-off valve (not shown) that is operative to stop the flow of air from the reservoir to the brake pipe and an air flow sensor (not shown) for measuring the rate of air flow into the brake pipe 112. This third example of implementation allows either one of the air flow test and the brake pipe leakage test to be performed.

Located at another end of the brake pipe 112 is an end of train unit 116. The end of train unit 116 can be a simple connection point suitable for allowing a portable pressure gauge to be connected thereto, or a functional unit for taking readings of the pressure at the end of the brake pipe 112. Although the pressure regulator and high pressure air reservoir, and the end of train unit 116 are described as being at opposing ends of the brake pipe 112, it should be understood that the pressure regulator and high pressure air reservoir, and the end of train unit 116 can be positioned anywhere along brake pipe 112 without detracting from the spirit of the invention.

In a specific example of implementation, the present invention includes a transmitter 120 for communicating by way of a communication link 122 with a slave controller 118 located on board the locomotive 102. As will be described further on, the transmitter 120 can be a portable device that is carried by an operator such that the operator can transmit commands to the slave controller 118 for causing corresponding actions to be performed at the train. The transmitter 120 is preferably remote from the train, which allows for placing the point of control at a remote location, thereby potentially enhancing safety, accuracy and efficiency. Furthermore, a portable transmitter provides for increased mobility of the operator who is no longer constrained to being on, or in very close proximity, to the train.

In a specific example of implementation, the transmitter 120 is an RF transmitter, and the communication link 122 is an RF communication link. As such, the RF transmitter is capable of transmitting RF signals over the RF communication link. Examples of such signals could be commands to initiate acceleration, forward or reverse motion, brake application, coasting and brake pipe testing amongst others.

FIG. 2 is a functional block diagram of the transmitter 120. The transmitter 120 includes three main components; namely a user interface 200, a control entity 202 and a communication entity 204. The physical layout of the transmitter 120 is not illustrated in the drawings because it can greatly vary without departing from the spirit of the invention. For example, the transmitter 120 can be in the form of a portable module including a housing that encloses the electronic circuitry and a battery for supplying electrical power therefor.

As mentioned above, the transmitter 120 includes a user interface 200 which, in a specific example of implementation, includes a plurality of manually operable levers, buttons and switches that project outside the housing and enable the user to enter a desired command. Alternatively, the user interface 200 may include a keyboard, touch sensitive screen, pointing device or speech recognition capabilities, among others. In a specific non-limiting embodiment, the user interface 200 includes a brake pipe testing lever, button or switch that is operable by a user to initiate brake pipe testing. It will be appreciated that any suitable input or combination of inputs may be used for providing this command, such as, a keyboard, a touch sensitive screen, a pointing device or speech recognition capabilities as mentioned above. The user interface 200 then generates electrical signals that are directed to the control entity 200. The control entity 200 receives the electrical signals from the user interface 200 and outputs digitized commands.

Typically, the commands are digitally encoded and represented as an arrangement of bits in a data frame. Various possible frame formats can be considered without departing from the spirit of the invention. The data frames generated by the control entity 202 are directed to the communication entity 204 that produces an RF signal containing the data frames to be sent over the RF communication link 122.

In the example shown in the drawings, the communication entity 204 has bi-directional communication capabilities. As such, the communication entity 204 can send signals to and receive signals from the slave controller 118. Accordingly, the communication entity 204 has a transmitter section to handle outgoing signals and a receiver section to handle incoming signals.

In an alternative implementation, the transmitter 120 is equipped with a communication entity 204 that is uni-directional and includes only a transmitter section to handle outgoing signals. In such an embodiment, confirmation can be received via a “talker” unit located on the locomotive 102. A “talker” unit is an audio unit that contains pre-recorded phrases that can be sent back to the operator by way of transmission over voice radio.

The various components of the transmitter 120 are implemented in hardware and/or software.

The signals issued by the transmitter 120 are received by the slave controller 118, which is shown in greater detail in the block diagram of FIG. 3. The slave controller 118 includes two components; namely a control entity 300 and a communication entity 302. The communication entity 302 is similar to the communication entity 204 described above in relation to transmitter 120.

In particular, in accordance with a first example of implementation, the communication entity 302 includes receiver and transmitter sections (not shown) for bi-directional communication with the transmitter 120 over communication link 122.

In accordance with an alternative example of implementation, the communication entity 302 includes a receiver section only (not shown) for receiving signals from the transmitter 120 over communication link 122.

The communication entity 302 is also in communication with the control entity 300 and communicates the signals received from transmitter 120 to the control entity 300. The control entity 300 is responsive to the signals conveying the commands issued by the transmitter 120, for issuing corresponding local control signals over communication link 304 to a control interface 306 for causing corresponding actions to be performed at the train. For example, the control entity 300 is responsive to a signal conveying an acceleration command sent by the transmitter 120 for issuing local control signals to the control interface 306 for applying a throttle setting and causing the locomotive to move. In addition, the control entity 300 is responsive to a signal conveying a brake pipe testing command for issuing local control signals to the control interface 306 for causing a brake pipe testing to be initiated.

As used herein, the term “control interface” refers globally to the collection of various actuators located on the train for executing various commands issued by the control entity 300 of the slave controller 118. Examples of such actuators include the actuators that control the throttle, the brakes, the pressure regulator and the air flow sensor, among others.

In a specific example of implementation, communication link 304 is a physical link made up of wires (possibly including an optical fiber) connecting the control entity 300 to the various actuators. It should, however, be understood that wireless communication links, such as radio frequency and infrared, can also be used for communication link 304 without departing from the spirit of the invention.

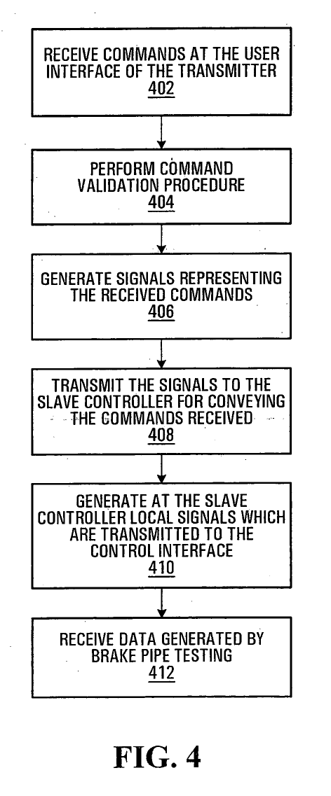

The process for performing brake pipe testing will now be described in greater detail with respect to the flowchart appearing in FIG. 4 and with reference to FIGS. 2 and 3. The process starts at step 402 wherein, as described above, the operator of the transmitter enters a desired command or commands via the user interface 204 (shown in FIG. 2). In the specific embodiment described herein, the user sets the levers, buttons or switches, so as to indicate a brake pipe testing command for causing brake pipe testing to be initiated. Optionally, the user interface 204 may allow the user to select between either performing a brake pipe leakage test or an airflow test for testing the brake pipe. In such a case, a manually operable user input is provided to effect this selection. Alternatively, a default brake pipe testing method is used and therefore no option is provided to the user.

In yet another alternative embodiment, the brake pipe testing can occur automatically under certain conditions, and does not explicitly require a signal to be entered by an operator. For example, the transmitter 120 may transmit a signal indicative that brake pipe testing could be initiated automatically, each time the brake pipe is re-charged.

At step 404 the control entity 202 (shown in FIG. 2) performs a command validation procedure on the signal. The command validation procedure generally includes a set of rules that are established based on safety requirements and/or other criteria. It is this set of rules and criteria that dictates whether or not a command can be transmitted to the slave controller 118. For example, one of the rules could be that brake pipe testing cannot be performed while an acceleration command is being transmitted or while the train is in motion (i.e. the train must be stationary in order to perform this test). As such, upon receipt of a brake pipe testing command signal, the control entity 202 will firstly perform the command validation procedure in order to verify that the train is not in motion. The reader will appreciate that the validation procedure rules can be varied widely and will depend on the intended application.

Alternatively, the command validation procedure may be effected by the control entity 300 in the slave controller instead of by the control entity 202. This alternative configuration is particularly useful when the transmitter 120 is uni-directional and includes only a transmitter section to handle outgoing signals and therefor cannot receive status information from the locomotive. Consequently, in such an alternative configuration, step 404 is performed at a later time in the process by the control entity 300 in the slave controller.

At step 406, the control entity 202 generates an internal digital signal representing a brake pipe testing command. In the alternative implementation where the operator is enabled. to select between a brake pipe leakage test and an airflow test, the internal digital signal is indicative of the desired brake pipe test. The internal signal generated by the control entity 202 is directed to the communication entity 204, which processes the signal accordingly and then at step 408 transmits an RF signal containing the command to the slave controller 118 over communication link 122.

At step 410, the control entity 300 is responsive to the signal issued by the transmitter 120 to issue a local control signal to the control interface 306 for causing the brake pipe testing to be initiated. Depending on whether the brake pipe test being performed is the brake pipe leakage test or the airflow test, step 412 will be slightly different. As such, the rest of the description will focus on describing the steps performed during the brake pipe leakage test and during the airflow test. Both of these tests can be performed using a semi-automated system or a filly automated system, and as such, both the semi-automated and the filly automated systems will be described herein.

Semi-Automated System

In a specific example of implementation of a semi-automated system, the end of train unit 116 is in the form a connection point for allowing a portable pressure gauge to be connected thereto. Alternatively, instead of a portable gauge, the end of train unit 116 is equipped with a pressure gauge that is affixed thereto and that is adapted to provide a measure of the pressure within the brake pipe. When the brake pipe test is being performed using the semi-automated system, the operator of transmitter 120 is positioned next to the end of train unit 116.

Brake Pipe Leakage Test

In a first specific example, the brake pipe test to be performed is a brake pipe leakage test. In response to a signal for initiating the brake pipe test, local control signals are issued by the control entity 300 to the control interface 306 to cause the pressure regulator to bring the air pressure in the brake pipe 112 up to a predetermined level. Typically, the air brake system is charged to the pressure at which the train will be operated. A user positioned at the end of train unit 116 installs a portable gauge into the end of train unit 116 in order to determine if the pressure at the end of the brake pipe 112 is within a certain desired range. In a non-limiting example, the brake pipe is considered to be charged to the predetermined level when the pressure at the end of the train is within about 15 psi of the pressure at which the train will be operated, but not less than about 75 psi. Alternatively, instead of a portable gauge, the end of train unit may be equipped with a pressure gauge that is affixed thereto and that is adapted to provide a measure of the pressure within the brake pipe 112. When the pressure at the end of the brake pipe is within the certain range, the user transmits via transmitter 120 a signal to the slave controller 118 indicating that the charging is complete.

A brake pipe service reduction is then caused to occur. In a non-limiting implementation, a brake pipe service reduction of about 20 psi. is caused to occur. The brake pipe service reduction may be caused by the operator issuing an appropriate control signal through transmitter 120 to the slave controller 118 in order to instruct the brake pipe service reduction to occur. Alternatively, the slave controller may automatically cause a brake pipe service reduction in response to the signal indicating that the charging is complete.

After the brake pipe service reduction, the slave controller 118 causes the brake valve to be lapped and any pressure maintaining functionality for the brake pipe to be disabled. After a delay period, the brake pipe leakage is noted. In a non-limiting implementation, the delay period is in the range of 45-60 seconds. In a first implementation, the brake pipe leakage is noted on the basis of the pressure measure of the portable brake pipe gauge used by the operator. In a second implementation, the brake pipe leakage is noted on the basis of the pressure measure of the pressure gauge that is affixed thereto.

If the brake pipe leakage is less than a certain threshold leakage rate value, the brake pipe leakage test is considered to have been passed. The rate of leakage can be determined based on the initial pressure reading and the reading taken after a predetermined amount of time. In a non-limiting implementation, the threshold leakage rate value is about 5 psi per minute however other threshold leakage values may be used without detracting from the spirit of the invention.

Although the above-described example of implementation includes causing a brake pipe service reduction to occur, the brake pipe leakage test may be effected without a brake pipe service reduction. In an example of such an implementation, once the brake pipe pressure has been brought to a predetermine level, the signal transmitted to the slave controller 118 indicates that the pressure regulator should temporarily cease to provide air to the brake pipe 112. As such, the pressure in the brake pipe 112 will be influenced mainly by the air leakage due to imperfect joints or connections, during the test. After a predetermined amount of time has passed, the operator uses the portable pressure gauge to measure the pressure at the end of the brake pipe. Alternatively, the brake pipe leakage is noted on the basis of the pressure measure of the pressure gauge that is affixed thereto.

In yet another alternative, the brake pipe pressure can be measured at the head of the locomotive. The rate of leakage can then be determined based on the initial pressure reading and the reading taken after a predetermined amount of time.

The slave controller 118 then conveys information indicative of the leakage test results to the operator of the transmitter 120. The test results are conveyed to the operator of transmitter 120 using any suitable communication device. In a first example, the test results may be broadcast over a speaker or “talker”, as described above. In a second example, a signal indicative of the test result is transmitted to a visual display device.

In a third example of implementation, a signal indicative of the test results is transmitted over a wireless link 122 to transmitter 120. In such an implementation, transmitter 120 is equipped with a receiver portion adapted for receiving the signal issued by the slave controller 118 and communicating the test results to the operator of transmitter 120. The test results are communicated to the operator by the transmitter 120 using an audio output or a visual display.

The results of the brake pipe leakage test can be a specific measurement, such as the rate of pressure leakage, or can be a binary signal indicating whether or not the train has passed or failed the brake pipe leakage test. Where the test results are indicative of whether the leakage test was passed or failed, the slave controller 118 is equipped with processing capability adapted to determine whether the leakage test was passed or failed. The processing capability may be in the form of a program element implemented either in software components, hardware components or a combination of the two. Alternatively, the processing capability adapted to determine whether the leakage test was passed or failed may be positioned remotely from the slave controller 118. In such a case, the slave controller transmits a signal indicative of the measured leakage rate to the remote entity, which processes the signal indicative of the measured leakage rate to determine whether the leakage test is passed or failed. For example, the leakage rate may be transmitted to the transmitter 120 which is equipped with the processing capability to determine whether the leakage test was passed or failed.

Airflow Test

In a second specific example of implementation, the brake pipe test to be performed is an airflow test. In response to a command from the transmitter 120 to initiate the brake pipe test, local control signals are issued by the control entity 300 to the control interface 306 to cause the pressure regulator to bring the air pressure in the brake pipe 112 up to a predetermined level. Typically, the air brake system is charged to the pressure at which the train will be operated. A user positioned at the end of train unit 116 installs a portable gauge into the end of train unit 116 in order to determine if the pressure at the end of the brake pipe 112 is within a certain desired range. In a non-limiting example, the brake pipe is considered to be charged to the predetermined level when the pressure at the end of the train is within about 15 psi of the pressure at which the train will be operated, but not less than about 75 psi. Alternatively, instead of a portable gauge, the end of train unit 116 may be equipped with a pressure gauge that is affixed thereto and that is adapted to provide a measure of the pressure within the brake pipe. When the pressure at the end of the brake pipe is within the certain range, the user transmits via transmitter 120 a signal to the slave controller 118 indicating that the charging is complete.

Once the brake pipe is charged, the pressure in the brake pipe is maintained at a desired level using well-known pressure maintaining systems. Such systems typically make use of a feedback-loop which controls the airflow from the pressure regulator on the basis of the change in pressure in the brake pipe. At this point an airflow sensor takes a measurement of the rate of airflow into the brake pipe 112 to determine the airflow required for maintaining the desired pressure. Typically, the airflow sensor is located near the pressure regulator however the position of the airflow sensor may vary without detracting from the spirit of the invention. Typically, the airflow test is considered to be passed if the airflow does not exceed 60 cubic feet per minute. The airflow test results are then conveyed to the operator of transmitter 120.

In a first example of implementation, the airflow sensor transmits a signal indicative of this measurement to the slave controller 118. The slave controller 118 then conveys information indicative of the airflow test results data to the operator of the transmitter 120. The test results are conveyed to the operator of transmitter 120 using any suitable communication device. In a first example, the test results are broadcast over a speaker or “talker” as described above. In a second example, a signal indicative of the test result is transmitted to a visual display device.

In a third example of implementation, a signal indicative of the test results is transmitted over a wireless link 122 to transmitter 120. In such an implementation, transmitter 120 is equipped with a receiver portion adapted for receiving the signal issued by the slave controller 118 and communicating the test results to the operator of transmitter 120. The test results are communicated to the operator by the transmitter 120 using an audio output or a visual display.

The test results may be indicative of the measured airflow rate or, alternatively, of whether the airflow test was passed or failed. Where the test results are indicative of whether the airflow test was passed or failed, the slave controller 118 is equipped with processing capability adapted to determine whether the airflow test was passed or failed. The processing capability may be in the form of a program element implemented either in software components, hardware components or a combination of the two. Alternatively, the processing capability adapted to determine whether the airflow test was passed or failed may be positioned remotely from the slave controller 118. In such a case, the slave controller transmits a signal indicative of the measured airflow rate to the remote entity, which processes the signal indicative of the measured airflow rate to determine whether the airflow test is passed or failed. For example, the measured airflow rate may be transmitted to the transmitter 120 the latter one of which is equipped with the processing capability adapted to determine whether the airflow test was passed or failed.

Fully-Automated System

In a specific example of implementation of a fully automated system, the end of train unit 116 is in the form of a functional unit adapted for taking readings of the pressure at the end of the brake pipe 112 and for communication this reading to a remote entity. For example, the end of train unit 116 can include sensors that are able to take pressure readings, and transmit those readings to the slave controller 118. When the brake pipe test is being performed using the fully-automated system, the operator of transmitter 120 may be positioned anywhere provided that the transmitter 120 is within the transmission range of the slave controller 118. In other words, the operator of transmitter 120 is positioned remotely from the train.

Brake Pipe Leakage Test

In a first specific example, the brake pipe test to be performed is a brake pipe leakage test. In response to a command from the transmitter 120 to initiate the brake pipe test, local control signals are issued by the control entity 300 to the control interface 306 to cause the pressure regulator to bring the air pressure in the brake pipe 112 up to a predetermined level. Typically, the air brake system is charged to the pressure at which the train will be operated.

The end of train unit 116 monitors the pressure at the end of the train. In a non-limiting example, the brake pipe is considered to be charged to the predetermined level when the pressure at the end of the train is within about 15 psi of the pressure at which the train will be operated, but not less than about 75 psi. When the pressure at the end of the brake pipe is within the above-described certain range, the charging of the brake pipe is complete.

In a first example of implementation, the end of train unit 116 is adapted for communicating with the slave controller 118 for providing the latter with measurements of the pressure at the end of the brake pipe. In a specific implementation of the invention, the end of train unit 116 is operable to transmit a signal to slave controller 118 for conveying a plurality of air pressure measurements taken at different instants in time. The communication is effected over communication link 124. For the purposes of this description, the end of train unit 116 is considered part of control interface 306, such that communication link 124 can be the same link as communication link 304. Therefore, at step 412 the slave controller 118 receives a signal from the control interface 306 conveying data from the end of train unit. The slave controller 118 receives and processes the pressure measurements received from the end of train unit 116 to determine whether the pressure at the end of the brake pipe is within the certain range. In this implementation, the slave controller 118 is equipped with processing capability adapted to determine whether the pressure at the end of the brake pipe is

within the certain range. The processing capability may be in the form of a program element implemented either in software components, hardware components or a combination of the two.

In a second example of implementation, the end of train unit 116 is adapted for processing the pressure measurements in order to determine whether the brake pipe is charged up to the desired level. Once the end of train unit 116 has determined that the pressure at the end of the brake pipe is within a certain range, then the end of train unit 116 transmits a signal to the slave controller 118 via communication link 124 to indicative that the brake pipe pressure is within the desired range. For the purposes of this description, the end of train unit 116 is considered part of control interface 306, such that communication link 124 can be the same link as communication link 304. Therefore, at step 412 the slave controller 118 receives a signal from the control interface 306 conveying data from the end of train unit. In this implementation, the end of train unit 116 is equipped with processing capability adapted to determine whether the pressure at the end of the brake pipe is within a certain range and to issue a message to the slave controller 118 when it is determined that the brake pipe pressure is within the certain range. The processing capability may be in the form of a program element implemented either in software components, hardware components or a combination of the two.

In a third example of implementation, the end of train unit 116 is adapted for communicating with transmitter 120 for providing the latter with measurements of the pressure at the end of the brake pipe. In a specific implementation of the invention, the end of train unit 116 is operable to transmit a signal to transmitter 120 for conveying a plurality of air pressure measurements taken at different instants in time. The communication is effected over a wireless communication link (not-shown). The transmitter 120 receives and processes the pressure measurements received from the end of train unit 116 to determine whether the pressure at the end of the brake pipe is within the certain range. In this implementation, the transmitter 120 is equipped with a receiver portion and with processing capability adapted to determine whether the pressure at the end of the brake pipe is within the certain range. The processing capability may be in the form of a program element implemented either in software components, hardware components or a combination of the two.

Once the brake pipe pressure is determined to be within a certain range, a brake pipe service reduction is then caused to occur. In a non-limiting implementation, a brake pipe service reduction of about 20 psi. is caused to occur.

In a first example, the slave controller conveys to the operator of the transmitter 120 the completion of the charging of the brake pipe. The operator then issues an appropriate control signal through transmitter 120 to the slave controller 118 in order to instruct the brake pipe service reduction to occur.

In a second example of implementation, the slave controller 118 is adapted to automatically cause a brake pipe service reduction in response to the determination that the charging is complete.

In a third example of implementation, the transmitter 120 conveys to the operator the completion of the charging of the brake pipe. The operator then issues an appropriate control signal through transmitter 120 to the slave controller 118 in order to instruct the brake pipe service reduction to occur.

After the brake pipe service reduction, the slave controller 118 causes the brake valve to be lapped and any pressure maintaining functionality for the brake pipe to be disabled. After a delay period, the brake pipe leakage is noted. In a non-limiting implementation, the delay period is in the range of 45-60 seconds.

In a first implementation, the end of train unit transmits measurements of the brake pipe pressure to the slave controller 118. The slave controller 118 includes the necessary processing capability for deriving the leakage rate corresponding to the change in brake pipe pressure. In a second implementation, the end of train unit is adapted for processing the measurements of the brake pipe pressure to derive the corresponding leakage rate. The leakage rate is then transmitted to the slave controller 118. In this configuration, the end of train unit includes the necessary processing capability for deriving the leakage rate corresponding to the change in brake pipe pressure. In yet another implementation, the end of train unit 116 has augmented capabilities and can determine whether the brake pipe leakage test was passed or failed. In this configuration, the end of train unit includes the necessary processing capability for deriving the leakage rate corresponding to the change in brake pipe pressure as well as whether the test was passed or failed. In a third implementation, the end of train unit 116 is adapted for communicating with transmitter 120 for providing the latter with measurements of the pressure at the end of the brake pipe. The transmitter 120 then computes the leakage rate. In this configuration, the transmitter 120 includes the necessary processing capability for deriving the leakage rate corresponding to the change in brake pipe pressure. Optionally, the transmitter 120 may also be adapted for determining whether the brake pipe leakage test is passed or failed.

The information indicative of the leakage test results are then conveyed to the operator of the transmitter 120 using any suitable communication device. In the case whether the transmitter 120 derives the leakage rate locally, the test results may be communicating either visually or through an audio output on the transmitter 120.

In the case where the test results are either sent to the slave controller or computed by the slave controller, the test results may be conveyed to the operator of the transmitter 120 using any suitable communication device. In a first example, the test results may be broadcast over a speaker. In a second example, a signal indicative of the test result is transmitted to a visual display device. In a third example of implementation, a signal indicative of the test results is transmitted over a wireless link 122 to transmitter 120. In such an implementation, transmitter 120 is equipped with a receiver portion adapted for receiving the signal issued by the slave controller 118 and communicating the test results to the operator of transmitter 120. The test results are communicated to the operator by the transmitter 120 using an audio output or a visual display.

The test results may be indicative of the leakage rate or, alternatively, of whether the brake pipe leakage test was passed or failed. Where the test results are indicative of whether the brake pipe leakage test was passed or failed, the slave controller 118 is equipped with processing capability adapted to determine whether the brake pipe leakage test was passed or failed. The processing capability may be in the form of a program element implemented either in software components, hardware components or a combination of the two. Alternatively, the processing capability adapted to determine whether the brake pipe leakage test was passed or failed may be positioned remotely from the slave controller 118. In such a case, the slave controller transmits a signal indicative of the leakage rate to the remote entity, which processes the signal indicative of the leakage rate to determine whether the brake pipe leakage test is passed or failed. For example, the leakage rate may be transmitted to the transmitter 120 the latter one of which is equipped with the processing capability adapted to determine whether the brake pipe leakage test was passed or failed.

If the brake pipe leakage is less than a certain threshold leakage rate value, the brake pipe leakage test is considered to have been passed. The rate of leakage can be determined based on the initial pressure reading and the reading taken after a predetermined amount of time. In a non-limiting implementation, the threshold leakage rate value is about 5 psi per minute however other threshold leakage values may be used without detracting from the spirit of the invention.

Although the above-described example of implementation includes causing a brake pipe service reduction to occur, in the brake pipe leakage test may be effected without a brake pipe service reduction. In an example of such an implementation, once the brake pipe pressure has been brought to a predetermine level, the slave controller 118 temporarily ceases to provide air to the brake pipe 112. As such, the pressure in the brake pipe 112 will be influenced mainly by the air leakage due to imperfect joints or connections, during the test. The end of train unit 116 then provides pressure measurements of the brake pipe to the slave controller 118 which then derives the corresponding brake pipe leakage rate. Alternatively, the end of train unit 116 computes the brake pipe leakage rate that it then provides to the slave controller 118. In yet another alternative, the end of train unit 116 (or the slave controller 118) provides pressure measurements of the brake pipe to the transmitter 120. The transmitter then computes the then derives the corresponding brake pipe leakage rate. The rate of leakage can then be determined based on the initial pressure reading and the reading taken after a predetermined amount of time

Information indicative of the leakage test results is then conveyed to the operator of the transmitter 120. The test results are conveyed to the operator of transmitter 120 using any suitable communication device. In a first example, the test results may be broadcast over a speaker. In a second example, a signal indicative of the test result is transmitted to a visual display device.

In a third example of implementation, a signal indicative of the test results is transmitted over a wireless link to transmitter 120. In such an implementation, transmitter 120 is equipped with a receiver portion adapted for receiving the signal issued by the slave controller 118 and communicating the test results to the operator of transmitter 120. The test results are communicated to the operator by the transmitter 120 using an audio output or a visual display.

The results of the brake pipe leakage test can be a specific measurement, such as the rate of pressure leakage, or can be a binary signal indicating whether or not the train has passed or failed the brake pipe leakage test. Where the test results are indicative of whether the brake pipe leakage test was passed or failed, the slave controller 118 is equipped with processing capability adapted to determine whether the leakage test was passed or failed. The processing capability may be in the form of a program element implemented either in software components, hardware components or a combination of the two. Alternatively, the processing capability adapted to determine whether the leakage test was passed or failed may be positioned remotely from the slave controller 118. In such a case, the slave controller transmits a signal indicative of the measured leakage rate to the remote entity, which processes the signal indicative of the measured leakage rate to determine whether the leakage test is passed or failed. For example, the leakage rate may be transmitted to the transmitter 120 the latter one of which is equipped with the processing capability adapted to determine whether the leakage test was passed or failed.

Airflow Test

In a second specific example, the brake pipe test to be performed is an airflow test. In response to a command from the transmitter 120 to initiate the brake pipe test, local control signals are issued by the control entity 300 to the control interface 306 to cause the pressure regulator to bring the air pressure in the brake pipe 112 up to a predetermined level. Typically, the air brake system is charged to the pressure at which the train will be operated.

The end of train unit 116 monitors the pressure at the end of the train. In a non-limiting example, the brake pipe is considered to be charged to the predetermined level when the pressure at the end of the train is within about 15 psi of the pressure at which the train will be operated, but not less than about 75 psi. When the pressure at the end of the brake pipe is within the above-described certain range, the charging of the brake pipe is complete is complete.

In a first example of implementation, the end of train unit 116 is adapted for communicating with the slave controller 118 for providing the latter with measurements of the pressure at the end of the brake pipe. In a specific implementation of the invention, the end of train unit 116 is operable to transmit a signal to slave controller 118 for conveying a plurality of air pressure measurements taken at different instants in time. The communication is effected over communication link 124. For the purposes of this description, the end of train unit 116 is considered part of control interface 306, such that communication link 124 can be the same link as communication link 304. Therefore, at step 412 the slave controller 118 receives a signal from the control interface 306 conveying data from the end of train unit. The slave controller 118 receives and processes the pressure measurements received from the end of train unit 116 to determine whether the pressure at the end of the brake pipe is within the certain range. In this implementation, the slave controller 118 is equipped with processing capability adapted to determine whether the pressure at the end of the brake pipe is within the certain range. The processing capability may be in the form of a program element implemented either in software components, hardware components or a combination of the two.

In a second example of implementation, the end of train unit 116 is adapted for processing the pressure measurements in order to determine whether the brake pipe up is charged up to the desired level. Once the end of train unit 116 has determined that the pressure at the end of the brake pipe is within a certain range, then the end of train unit 116 transmits a signal to the slave controller 118 via communication link 124 to indicative that the brake pipe pressure is within the desired range. For the purposes of this description, the end of train unit 116 is considered part of control interface 306, such that communication link 124 can be the same link as communication link 304. Therefore, at step 412 the slave controller 118 receives a signal from the control interface 306 conveying data from the end of train unit. In this implementation, the end of train unit 116 is equipped with processing capability adapted to determine whether the pressure at the end of the brake pipe is within a certain range and to issue a message to the slave controller 118 when it is determined that the brake pipe pressure is within the certain range. The processing capability may be in the form of a program element implemented either in software components, hardware components or a combination of the two.

In a third example of implementation, the end of train unit 116 is adapted for communicating with transmitter 120 for providing the latter with measurements of the pressure at the end of the brake pipe. In a specific implementation of the invention, the end of train unit 116 is operable to transmit a signal to transmitter 120 for conveying a plurality of air pressure measurements taken at different instants in time. The communication is effected over a wireless communication link (not-shown). The transmitter 120 receives and processes the pressure measurements received from the end of train unit 116 to determine whether the pressure at the end of the brake pipe is within the certain range. In this implementation, the transmitter 120 is equipped with a receiver portion and with processing capability adapted to determine whether the pressure at the end of the brake pipe is within the certain range. The processing capability may be in the form of a program element implemented either in software components, hardware components or a combination of the two.

Once the brake pipe is charged, the pressure in the brake pipe is maintained at a desired level using well-known pressure maintaining systems. Such systems typically make use of a feedback-loop that controls the airflow from the pressure regulator on the basis of the change in pressure in the brake pipe. At this point an airflow sensor takes a measurement of the rate of airflow into the brake pipe 112 to determine the airflow required for maintaining the desired pressure. Typically, the airflow sensor is located near the pressure regulator however the position of the airflow sensor may vary without detracting from the spirit of the invention. Typically, the airflow test is considered to be passed if the airflow does not exceed 60 cubic feet per minute. The airflow test results are then conveyed to the operator of transmitter 120.

The test results may be conveyed in a manner similar to that described with regards to the semi-automated system and as such will not be described in further detail here.

In the case Where the locomotive 102 fails the brake pipe leakage test, the failed result can be linked to other functions of the system. For example, upon failing the brake pipe leakage test, the locomotive 102 can prevent the locomotive 102 from making any further movements until the brake pipe 112 has passed the brake pipe leakage test.

Although various embodiments have been illustrated, this was for the purpose of describing, but not limiting, the invention. Various modifications will become apparent to those skilled in the art and are within the scope of this invention, which is defined more particularly by the attached claims.

1) A transmitter for remotely controlling and testing a train having a locomotive in which is mounted a slave controller, said transmitter comprising:
a) a control entity for issuing a plurality of commands to the slave controller for causing corresponding actions to be performed at the train;
b) the plurality of commands including a brake testing command for causing a brake pipe test to be initiated at the train;
c) a communication entity in communication with said control entity for receiving commands issued by said control entity and for transmitting a signal over a communication link to the slave controller for conveying the commands issued by said control entity.

2) A transmitter as defined in claim 1, wherein said communication link is an RF communication link, and the signal being transmitted is an RF signal.

3) A transmitter as defined in claim 2, wherein the brake pipe test is either one of a brake pipe leakage test or an airflow test.

4) A transmitter as defined in claim 3, wherein said transmitter includes a visual indicator for displaying to a human operator results of the brake pipe test, said control entity being responsive to an RF signal received by said communication entity over the RF communication link, the RF signal conveying data derived from the brake pipe test to drive said visual indicator.

5) A transmitter as defined in claim 4, wherein the data derived from the brake pipe test includes data indicative of whether the test was passed or failed.

6) A transmitter as defined in claim 4, wherein the data derived from the brake pipe test includes a plurality of air pressure measurements.

7) A transmitter as defined in claim 6, wherein said control entity is adapted for computing from the plurality of air pressure measurements a data element indicative of whether the test was passed or failed.

8) A transmitter as defined in claim 5, comprising a user interface in communication with said control entity, said user interface comprising said visual indicator.

9) A transmitter as defined in claim 8, wherein said user interface includes a brake pipe test initiating command operable by a user, said control entity being responsive to operation of said brake pipe test initiating command to initiate a brake pipe test.

10) A transmitter as defied in claim 8, wherein the brake pipe test initiating command is a command for initiating a brake pipe leakage test.

11) A transmitter as defined in claim 8, wherein the brake pipe test initiating command is a command for initiating an air flow test.

12) A transmitter as defined in claim 3, wherein said transmitter includes an audio output for conveying to a human operator results of the brake pipe test, said control entity being responsive to an RF signal received by said communication entity over the RF communication link, the signal conveying data derived from the brake pipe test to drive said audio output according to the data of the brake pipe test.

13) A transmitter as defined in claim 12, wherein the data derived from the brake pipe test includes a data element indicative of whether the test was passed or failed.

14) A transmitter as defined in claim 12, wherein the data derived from the brake pipe test includes a plurality of air pressure measurements.

15) A transmitter as defined in claim 14, wherein said control entity is adapted for computing from the plurality of air pressure measurements a data element indicative of whether the test was passed or failed.

16) A transmitter as defined in claim 12, comprising a user interface in communication with said control entity, said user interface comprising said audio output.

17) A slave controller for use in a locomotive having a control interface, said slave controller comprising:
a) a control entity;
b) a communication entity in communication with said control entity, said communication entity being adapted for receiving signals from a remote transmitter over a communication link conveying commands to said slave controller for causing corresponding actions to be performed at the locomotive;
c) said control entity being responsive to a brake testing command conveyed by signals in the communication link for issuing local control signals to the control interface for causing a brake pipe test to be initiated.

18) A slave controller as defined in claim 17, wherein said communication link is an RF communication link, and the signal being received is an RF signal.

19) A slave controller as defined in claim 18, wherein the local control signals issued to the control interface instruct the control interface to alter the air pressure in a brake pipe.

20) A slave controller as defined in claim 19, wherein said control entity is responsive to a signal received from the control interface conveying data generated by the brake pipe test, said RF communication entity outputting a signal over the RF communication link derived from the data generated by the brake pipe test.

21) A slave controller as defined in claim 20, wherein the data generated by the brake pipe test is the result of the brake pipe test, the signal output by said RF communication entity over the RF communication link including the results of the brake pipe test.

22) A slave controller as defined in claim 21, wherein the results of the brake pipe test includes a data element indicative of whether the brake pipe test was passed or failed.

23) A slave controller as defined in claim 21, wherein the brake pipe test is a brake pipe leakage test.

24) A slave controller as defined in claim 23, wherein the results of the brake pipe test includes a data element indicative of a brake pipe leakage rate.

25) A slave controller as defined in claim 23, wherein the data generated by the brake pipe leakage test includes a plurality of air pressure measurements, said control entity being adapted for computing from the plurality of air pressure measurements the results of the brake pipe leakage test, the signal output by said RF communication entity over the RF communication link containing the results of the brake pipe leakage test.

26) A slave controller as defined in claim 21, wherein the brake pipe test is an airflow test.

27) A slave controller as defined in claim 26, wherein the results of the brake pipe test includes a data element indicative of an airflow rate.

28) A slave controller as defined in claim 19, wherein said control entity is responsive to a signal received from the control interface conveying data generated by the brake pipe test, for conveying to an operator information indicative of a result of the brake pipe test.

29) A slave controller as defined in claim 28, wherein the results of the brake pipe test includes a data element indicative of whether the brake pipe test was passed or failed.

30) A slave controller as defined in claim 28, wherein the brake pipe test is a brake pipe leakage test.

31) A slave controller as defined in claim 30, wherein the results of the brake pipe test includes a data element indicative of a brake pipe leakage rate.

32) A slave controller as defined in claim 28, wherein the brake pipe test is an airflow test.

33) A slave controller as defined in claim 32, wherein the results of the brake pipe test includes a data element indicative of an airflow rate.

34) A method for remotely controlling and testing a train having a locomotive in which is mounted a slave controller, said method comprising:
a) providing a transmitter having a user interface for receiving a plurality of commands from the user, the plurality of commands including a brake testing command for causing a brake pipe test to be initiated at the train;
b) in response to a command entered at said user interface by the user, generating internal signals in the transmitter representing the command entered at said user interface,
c) using the internal signals to generate a communication to the slave controller conveying the command entered at said user interface.

35) A method as defined in claim 34, said method further comprising conveying a brake pipe test result to the user of the transmitter.

36) A method as defined in claim 35, wherein the brake pipe test result is conveyed using a visual display device.

37) A method as defined in claim 36, wherein the visual display device is part of the transmitter.

38) A method as defined in claim 35, wherein the brake pipe test result is conveyed using an audio device.

39) A method as defined in claim 36, wherein the audio device is part of the transmitter.

40) A method as defined in claim 35, wherein the brake pipe test result includes a data element indicative of whether the brake pipe test was passed or failed.

41) A method as defined in claim 35, wherein the brake pipe test is a brake pipe leakage test.

42) A method as defined in claim 41, wherein the brake pipe test result includes a brake pipe leakage rate.

43) A method as defined in claim 34, wherein the brake pipe test is an airflow test.

44) A method as defined in claim 43, wherein the brake pipe test result includes an airflow rate.
